(19) United States
(12) Patent Application Publication
(10) Pub. No.: US 2020/0081136 A1
(43) Pub. Date: Mar. 12, 2020

(54) POSITIONING METHOD AND DEVICE OF UNMANNED AERIAL VEHICLE

(71) Applicants: BEIJING JINGDONG SHANGKE INFORMATION TECHNOLOGY CO, LTD., Beijing (CN); BEIJING JINGDONG CENTURY TRADING CO., LTD., Beijing (CN)

(72) Inventor: Qi WANG, Beijing (CN)

(73) Assignees: BEIJING JINGDONG SHANGKE INFROMATION TECHNOLOGY CO. LTD., Beijing (CN); BEIJING JINGDONG CENTURY TRADING CO., LTD., Beijing (CN)

(21) Appl. No.: 16/493,619

(22) PCT Filed: Jan. 11, 2018
(86) PCT No.: PCT/CN2018/072259

§ 371 Date: Sep. 12, 2019

(30) Foreign Application Priority Data
Mar. 14, 2017 (CN) 201710148785.0

(51) Int. Cl. G01S 19/45; G01S 19/48; G01C 21/00

(52) U.S. Cl. CPC G01S 19/45; B64C 39/024; G01C 21/005; G01S 19/48

(57) ABSTRACT

A positioning method and a positioning device of an unmanned aerial vehicle (UAV). The positioning method includes receiving position information provided by a GPS and position information provided by an auxiliary positioning system; determining a positioning weight of the GPS and a positioning weight of the auxiliary positioning system; and calculating a position of the UAV in a weighted manner according to the position information provided by the GPS, the position information provided by the auxiliary positioning system, the positioning weight of the GPS and the positioning weight of the auxiliary positioning system.

### CROSS-REFERENCE TO RELATED APPLICATIONS

This application is based on and claims the benefit of priority to the Chinese patent application No. 201710148785.0 filed on Mar. 14, 2017, which is hereby incorporated by reference in its entirety into the present application.

### TECHNICAL FIELD

The present disclosure relates to the technical field of unmanned aerial vehicle (UAV), and in particular, to a positioning method and a positioning device of a UAV.

### BACKGROUND

A conventional UAV positioning method usually adopts global positioning system (GPS) for positioning, or adopts an auxiliary positioning system such as a visual positioning technology, an indoor positioning technology and the like for positioning.

### SUMMARY

The inventor has realized that: a positioning accuracy of GPS is relatively low. When the UAV is located at a take-off point or a landing point, a high positioning accuracy is required. At this time, only relying on GPS positioning may not meet the positioning requirement of the UAV. The positioning accuracy of the auxiliary positioning system is greatly affected by the environment, and thus the position information provided by the auxiliary positioning system is not accurate enough. How to improve the accuracy of positioning of the UAV is an urgent problem to be solved at present.

One technical problem solved by the present disclosure is how to improve the accuracy of positioning of the UAV.

According to one aspect of embodiments of the present disclosure, a positioning method of a UAV is provided, comprising: receiving position information provided by a GPS and position information provided by an auxiliary positioning system; determining a positioning weight of the GPS and a positioning weight of the auxiliary positioning system; and calculating a position of the UAV in a weighted manner according to the position information provided by the GPS, the position information provided by the auxiliary positioning system, the positioning weight of the GPS and the positioning weight of the auxiliary positioning system.

In some embodiments, determining a positioning weight of the GPS and a positioning weight of the auxiliary positioning system comprises: calculating a GPS positioning error; taking a physical quantity in negative correlation with the GPS positioning error as a GPS positioning accuracy coefficient, and taking a physical quantity in positive correlation with signal quality information of the auxiliary positioning system as an auxiliary positioning accuracy coefficient; and determining the positioning weight of the GPS and the positioning weight of the auxiliary positioning system according to the GPS positioning accuracy coefficient and the auxiliary positioning accuracy coefficient.

In some embodiments, a normalization operation is performed after taking reciprocal of the GPS positioning error to obtain a normalized GPS positioning accuracy coefficient; and a normalization operation is performed on the signal quality information of the auxiliary positioning system to obtain a normalized auxiliary positioning accuracy coefficient.

In some embodiments, calculating a GPS positioning error comprises: receiving horizontal dilution of precision, vertical dilution of precision and time dilution of precision from a satellite; and taking an arithmetic square root of a sum of squares of the horizontal dilution of precision, the vertical dilution of precision and the time dilution of precision as the GPS positioning error.

In some embodiments, the auxiliary positioning system is a wireless positioning system and the signal quality information of the auxiliary positioning system is wireless signal quality information.

In some embodiments, the auxiliary positioning system is a vision auxiliary positioning system, and the signal quality information of the auxiliary positioning system is image quality information of an image obtained by the UAV taking pictures of a ground.

In some embodiments, the wireless positioning system comprises: a Bluetooth positioning system, a wireless local area network positioning system, and a narrow bandwidth positioning system.

According to one aspect of embodiments of the present disclosure, a positioning device of a UAV is provided, wherein the positioning device comprises: an information receiving module configured to receive position information provided by a GPS and position information provided by an auxiliary positioning system; a weight determination module configured to determine a positioning weight of the GPS and a positioning weight of the auxiliary positioning system; and a position calculation module configured to calculate a position of the UAV in a weighted manner according to the position information provided by the GPS, the position information provided by the auxiliary positioning system, the positioning weight of the GPS and the positioning weight of the auxiliary positioning system.

In some embodiments, the weight determination module comprises: an error calculation unit configured to calculate a GPS positioning error; a positioning accuracy coefficient determination unit configured to take a physical quantity in negative correlation with the GPS positioning error as a GPS positioning accuracy coefficient and take a physical quantity in positive correlation with signal quality information of the auxiliary positioning system as an auxiliary positioning accuracy coefficient; and a weight determination unit configured to determine the positioning weight of the GPS and the positioning weight of the auxiliary positioning system according to the GPS positioning accuracy coefficient and the auxiliary positioning accuracy coefficient.

In some embodiments, the positioning accuracy coefficient determination unit is configured to: perform a normalization operation after taking reciprocal of the GPS positioning error to obtain a normalized GPS positioning accuracy coefficient; and perform a normalization operation on the signal quality information of the auxiliary positioning system to obtain a normalized auxiliary positioning accuracy coefficient.

In some embodiments, the auxiliary positioning system is a wireless positioning system and the signal quality information of the auxiliary positioning system is wireless signal quality information.

In some embodiments, the auxiliary positioning system is a vision auxiliary positioning system, and the signal quality information of the auxiliary positioning system is image quality information of an image obtained by the UAV taking pictures of a ground.

In some embodiments, the wireless positioning system comprises: a Bluetooth positioning system, a wireless local area network positioning system, and a narrow bandwidth positioning system.

According to one aspect of embodiments of the present disclosure, a positioning device of a UAV is provided, wherein the positioning device comprises: a memory; and a processor coupled to the memory, the processor being configured to execute the aforementioned positioning method of a UAV based on instructions stored in the memory.

According to one aspect of embodiments of the present disclosure, a computer-readable storage medium is provided, wherein the computer-readable storage medium stores computer instructions which, when executed by a processor, implement the aforementioned positioning method of a UAV.

The present disclosure calculates the position of the UAV in a weighted manner according to the position information provided by the GPS, the position information provided by the auxiliary positioning system, the positioning weight of the GPS and the positioning weight of the auxiliary positioning system, and therefore the accuracy of positioning of the UAV is improved.

Other features and advantages of the present disclosure will become clear from the following detailed descriptions of the illustrative embodiments of the present disclosure with reference to accompanying drawings.

### BRIEF DESCRIPTION OF THE DRAWINGS

In order to illustrate the technical solutions of the embodiments of the present disclosure or prior art more clearly, a brief description will be given below for the drawings required to be used in the description of the embodiments or technical solutions in prior art. It is obvious that, the drawings illustrated as follows are merely some of the embodiments of the present disclosure. For an ordinary skilled in the art, he or she may also acquire other drawings according to such drawings without paying inventive efforts.

FIG. 1 illustrates a schematic flow chart of some embodiments of a positioning method of a UAV of the present disclosure.

FIG. 2 illustrates a schematic flow chart of some embodiments of determining a positioning weight of a GPS and a positioning weight of an auxiliary positioning system.

FIG. 3 illustrates a schematic structural view of some embodiments of a positioning device of a UAV of the present disclosure.

FIG. 4 illustrates a schematic structural view of some embodiments of a weight determination module.

FIG. 5 illustrates a structural view of further embodiments of a positioning device of a UAV of the present disclosure.

FIG. 6 illustrates a structural view of still further embodiments of a positioning device of a UAV of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only a part of the embodiments of the present disclosure instead of all of them. The following descriptions on at least one illustrative embodiment are actually illustrative, but shall not set any limitation on the present disclosure and its application or utilization. All other embodiments that are obtainable to those skilled in the art based on the embodiments of the present disclosure without any creative effort are included in the protection scope of the present disclosure.

The inventor analyzes the positioning method in the prior art and points out that the reason why the accuracy of positioning of the UAV is low in the prior art is as follows: the UAV is positioned by adopting a relatively single positioning method, and the inherent defects of the positioning method cannot be overcome all the time; and no matter which existing positioning method is adopted, the static positioning process will result in a certain degree of one-sidedness of the result of positioning.

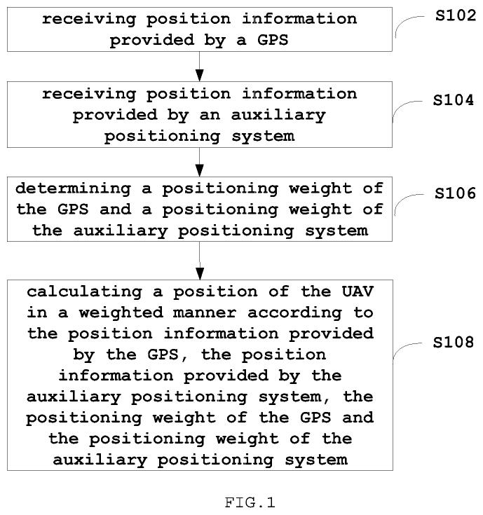

In view of this, the inventor adopts a data fusion algorithm of the UAV auxiliary positioning system and the GPS positioning system to realize dynamic positioning of the UAV according to different positioning accuracies of multiple positioning systems. Some embodiments of a positioning method of a UAV provided by the present disclosure are described below with reference to FIG. 1.

FIG. 1 illustrates a schematic flow chart of some embodiments of a positioning method of a UAV of the present disclosure. As shown in FIG. 1, the positioning method of these embodiment comprises steps S102 to S108.

In step S102, position information provided by a GPS is received.

For example, the UAV may receive position information provided by the GPS from a satellite, and the position information may be longitude, latitude, and altitude information.

In step S104, position information provided by the auxiliary positioning system is received.

The auxiliary positioning system can be a wireless positioning system, such as a Bluetooth positioning system, a wireless local area network positioning system or a narrow bandwidth positioning system. The auxiliary positioning system may also be a vision auxiliary positioning system.

In step S106, a positioning weight of the GPS and a positioning weight of the auxiliary positioning system are determined.

The specific process of determining the positioning weight of the GPS and the positioning weight of the auxiliary positioning system by the UAV is described in detail later.

In step S108, the position of the UAV is calculated in a weighted manner according to the position information provided by the GPS, the position information provided by the auxiliary positioning system, the positioning weight of the GPS and the positioning weight of the auxiliary positioning system.

For example, the position of the UAV can be calculated according to formula (1).

P=Qg*Pg+Qw*Pw (1)

wherein P represents the calculated position of the UAV, Pg represents the position information provided by the GPS, Pw represents the position information provided by the auxiliary positioning system, Qg represents the positioning weight of the GPS, and Qw represents the positioning weight of the auxiliary positioning system.

According to the above embodiments, it is necessary to dynamically determine the positioning weights of different positioning systems in real time during the operation of the UAV. By introducing data credibility of different positioning systems as positioning weights, a composite positioning method is used to position the UAV, which overcomes the inherent defects of a single positioning method, realizes dynamic positioning of the UAV, and improves the positioning accuracy of the UAV.

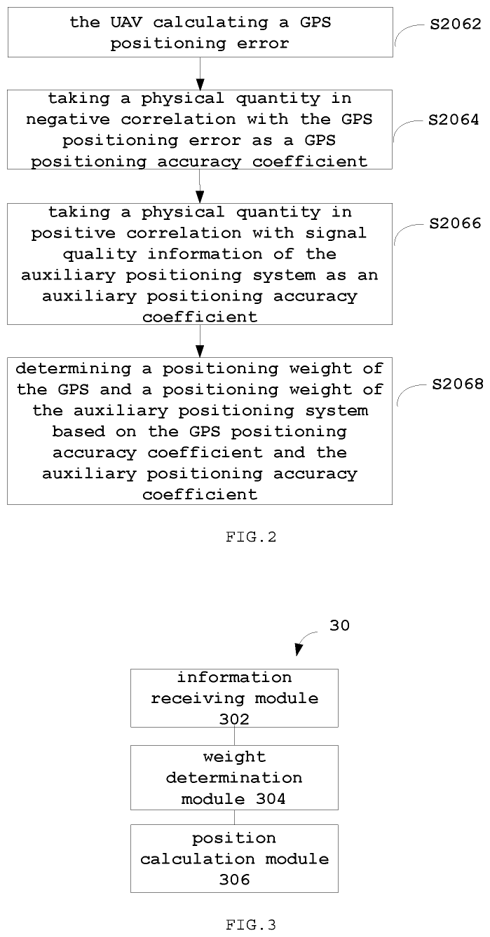

Some embodiments of determining a positioning weight of the GPS and a positioning weight of the auxiliary positioning system are described below with reference to FIG. 2.

FIG. 2 illustrates a schematic flow chart of some embodiments of determining a positioning weight of a GPS and a positioning weight of an auxiliary positioning system. As shown in FIG. 2, the implementation process of these embodiments comprises steps S2062 to S2068.

In step S2062, the UAV calculates a GPS positioning error.

For example, the UAV may receive an HDOP (horizontal dilution of precision), a VDOP (vertical dilution of precision), and a TDOP (time dilution of precision) from a satellite. Wherein the HDOP represents a positioning error of the GPS in the horizontal direction, the VDOP represents a positioning error of the GPS in the vertical direction, and the TDOP represents a time table offset error of the UAV. The UAV calculates a PDOP (position dilution of precision) according to formula (2), and further calculates a GPS positioning error GDOP according to formula (3), that is, an arithmetic square root of a sum of squares of the horizontal dilution of precision, the vertical dilution of precision and the time dilution of precision is taken as a GPS positioning error, wherein GDOP can reflect the positioning accuracy of the GPS.

HDOP²+VDOP²=PDOP² (2)

PDOP²+TDOP²=GDOP² (3)

In step S2064, a physical quantity in negative correlation with the GPS positioning error is taken as a GPS positioning accuracy coefficient.

It should be understood by those skilled in the art that the core idea of the present embodiment is to make the positioning weight higher when the positioning accuracy of the positioning system is higher. Therefore, for the GPS, the smaller the GPS positioning error, the higher the GPS positioning accuracy, that is, the higher the GPS positioning accuracy coefficient, the higher the corresponding positioning weight. Therefore, a physical quantity that is in negative correlation with the GPS positioning error can be taken as a GPS positioning accuracy coefficient. For example, a normalization operation may be performed after the reciprocal of the GDOP is taken, so as to obtain a normalized GPS positioning accuracy coefficient G′.

In step S2066, a physical quantity in positive correlation with signal quality information of the auxiliary positioning system is taken as an auxiliary positioning accuracy coefficient.

For example, the UAV performs a normalization operation on the signal quality information of the auxiliary positioning system to obtain a normalized auxiliary positioning accuracy coefficient. When the auxiliary positioning system is a wireless positioning system, the signal quality information of the auxiliary positioning system is wireless signal quality information. In wireless positioning technologies, the main factor affecting positioning accuracy is signal quality. The signal quality information of the wireless positioning system is normalized to obtain a normalized auxiliary positioning accuracy coefficient R′. When the auxiliary positioning system is a vision auxiliary positioning system, the signal quality information of the auxiliary positioning system is image quality information of an image obtained by the UAV taking pictures of a ground. In vision auxiliary positioning technologies, the image quality information may represent a positioning accuracy of the vision auxiliary positioning system.

Those skilled in the art will appreciate that there are many types of auxiliary positioning systems, and the auxiliary positioning systems given in the embodiments are examples only. The core idea of this embodiment is to find out a physical quantity that can represent a positioning accuracy of the auxiliary positioning system according to different auxiliary positioning systems so as to determine the weight.

In step S2068, a positioning weight of the GPS and a positioning weight of the auxiliary positioning system are determined based on the GPS positioning accuracy coefficient and the auxiliary positioning accuracy coefficient.

The UAV determines the positioning weight of the GPS and the positioning weight of the auxiliary positioning system according to a normalized GPS positioning accuracy coefficient and a normalized auxiliary positioning accuracy coefficient.

For example, the positioning weight of the GPS and the positioning weight of the auxiliary positioning system can be determined according to formula (4).

$$\begin{matrix}Qg = \frac{{G}^{′}}{{G}^{′} + {R}^{′}} & ( 4 ) \\ Qw = \frac{{R}^{′}}{{G}^{′} + {R}^{′}} & ( 5 )\end{matrix}$$

According to the above embodiments, the GPS signal is strong and the position information provided by the GPS is relatively accurate under the conditions of no shielding and good weather. However, the GPS positioning accuracy is reduced with the deterioration of the environment. On the other hand, the auxiliary positioning system at the take-off point or the landing point adopts a wireless positioning technology, of which the positioning accuracy is related to the quality of the wireless signals. The better the quality of the wireless signals the higher the positioning accuracy of the auxiliary positioning system.

According to the take-off process of the UAV, the signal strength of the auxiliary positioning system is strong when the UAV is near the ground, and the accuracy of the provided position is high, and the positioning weight is big; however, with the increase of the height of the UAV apart from the ground, the signal of the auxiliary positioning system weakens gradually, and the credibility of the auxiliary positioning system reduces. In contrast, as the environment becomes open gradually, the signal quality of the GPS becomes better gradually, and the GPS positioning weight increases. Therefore, in the take-off process of the UAV, the positioning system realizes the process of switching from the auxiliary positioning system to the GPS gradually. On the contrary, the positioning system realizes the process of switching from the GPS to the auxiliary positioning system in the landing process. According to the statistics of actual conditions, the positioning accuracy of the UAV can be remarkably improved by adopting the method provided by the present embodiments, and the ideal positioning error of the UAV can be down to 10 cm, and the average positioning error can be down to 20 cm.

Some embodiments of a positioning device of a UAV provided by the present disclosure are described below with reference to FIG. 3.

FIG. 3 illustrates a schematic structural view of some embodiments of a positioning device of a UAV of the present disclosure. As shown in FIG. 3, a positioning device 30 of the UAV in these embodiment comprises: an information receiving module 302, a weight determination module 304, and a position calculation module 306.

The information receiving module 302 is configured to receive position information provided by a GPS and position information provided by an auxiliary positioning system.

The weight determination module 304 is configured to determine a positioning weight of the GPS and a positioning weight of the auxiliary positioning system.

The position calculation module 306 is configured to calculate a position of the UAV in a weighted manner according to the position information provided by the GPS, the position information provided by the auxiliary positioning system, the positioning weight of the GPS and the positioning weight of the auxiliary positioning system.

According to the above embodiments, it is necessary to dynamically determine the positioning weights of different positioning systems in real time during the operation of the UAV. By introducing data credibility of different positioning systems as positioning weights, a composite positioning method is used to position the UAV, which overcomes the inherent defects of a single positioning method, realizes dynamic positioning of the UAV, and improves the positioning accuracy of the UAV.

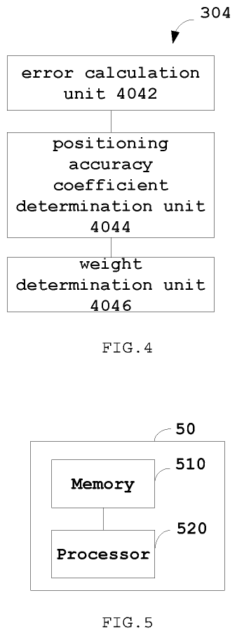

Some embodiments of the weight determination module are described below with reference to FIG. 4.

FIG. 4 illustrates a schematic structural view of some embodiments of a weight determination module. As shown in FIG. 4, the weight determination module 304 in this embodiment comprises: an error calculation unit 4042, a positioning accuracy coefficient determination unit 4044, and a weight determination unit 4046.

The error calculation unit 4042 is configured to calculate a GPS positioning error.

The positioning accuracy coefficient determination unit 4044 is configured to take a physical quantity in negative correlation with the GPS positioning error as a GPS positioning accuracy coefficient and take a physical quantity in positive correlation with signal quality information of the auxiliary positioning system as an auxiliary positioning accuracy coefficient.

The weight determination unit 4046 is configured to determine the positioning weight of the GPS and the positioning weight of the auxiliary positioning system according to the GPS positioning accuracy coefficient and the auxiliary positioning accuracy coefficient.

According to the above embodiments, the GPS signal is strong and the position information provided by the GPS is relatively accurate under the conditions of no shielding and good weather. However, the GPS positioning accuracy is reduced with the deterioration of the environment. On the other hand, the auxiliary positioning system at the take-off point or the landing point adopts a wireless positioning technology, of which the positioning accuracy is related to the quality of wireless signals. The better the quality of the wireless signals, the higher the positioning accuracy of the auxiliary positioning system.

According to the take-off process of the UAV, the signal strength of the auxiliary positioning system is strong when the UAV is near the ground, and the accuracy of the provided position is high, and the positioning weight is big; however, with the increase of the height of the UAV apart from the ground, the signal of the auxiliary positioning system weakens gradually, and the credibility of the auxiliary positioning system reduces. Relatively speaking, as the environment becomes open gradually, the signal quality of the GPS becomes better gradually, and the GPS positioning weight increases. Therefore, along with the take-off process of the UAV, the positioning system realizes the process of switching from an auxiliary positioning system to a GPS gradually. On the contrary, the positioning system realizes the process of switching from the GPS to the auxiliary positioning system in the landing process. According to the statistics of actual conditions, the positioning accuracy of the UAV can be remarkably improved by adopting the method provided by the present embodiment, and the ideal positioning error of the UAV can be down to 10 cm, and the average positioning error can be down to 20 cm.

In some embodiments, the positioning accuracy coefficient determination unit is configured to: perform a normalization operation after the reciprocal of the GPS positioning error is taken to obtain a normalized GPS positioning accuracy coefficient; and perform a normalization operation on the signal quality information of the auxiliary positioning system to obtain a normalized auxiliary positioning accuracy coefficient.

In some embodiments, the error calculation unit is configured to: receive horizontal dilution of precision, vertical dilution of precision and time dilution of precision from a satellite; and take an arithmetic square root of a sum of squares of the horizontal dilution of precision, the vertical dilution of precision and the time dilution of precision as the GPS positioning error.

In some embodiments, the auxiliary positioning system is a wireless positioning system and the auxiliary positioning system signal quality information is wireless signal quality information.

In some embodiments, the auxiliary positioning system is a vision auxiliary positioning system, and the signal quality information of the auxiliary positioning system is image quality information of an image obtained by the UAV taking pictures of a ground.

In some embodiments, the wireless positioning system comprises: a Bluetooth positioning system, a wireless local area network positioning system, and a narrow bandwidth positioning system.

FIG. 5 illustrates a structural view of further embodiments of a positioning device of a UAV of the present disclosure. As shown in FIG. 5, a positioning device 50 of a UAV of these embodiment comprises: a memory 510 and a processor 520 coupled to the memory 510, the processor 520 being configured to perform the positioning method of a UAV in any of the aforementioned embodiments based on instructions stored in the memory 510.

Memory 510 may comprise, for example, a system memory, a fixed non-volatile storage medium, and the like. The system memory stores, for example, an operating system, an application program, a Boot Loader, and other programs.

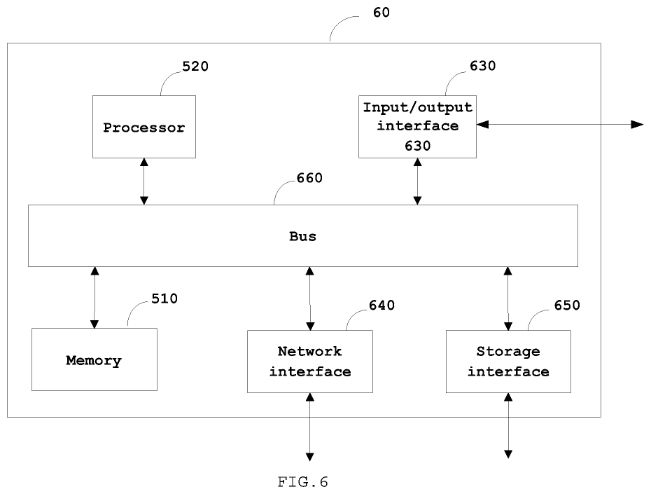

FIG. 6 illustrates a structural view of still further embodiments of a positioning device of a UAV of the present disclosure. As shown in FIG. 6, a positioning device 60 of the UAV of this embodiment comprises a memory 510 and a processor 520, and may also comprise an input/output interface 630, a network interface 640, a storage interface 650, and so forth. These interfaces 630, 640, 650, the memory 510 and the processor 520 may be connected, for example, via a bus 650. The input/output interface 630 provides a connection interface for input/output devices such as a display, a mouse, a keyboard, a touch screen, and the like. The network interface 640 provides a connection interface for various networking devices. The storage interface 650 provides a connection interface for an external storage device such as an SD card and a USB flash disk, etc.

The present disclosure also comprises a computer-readable storage medium having stored computer instructions thereon that, when executed by a processor, implement the positioning method of a UAV in any of the foregoing embodiments.

Those skilled in the art will appreciate that embodiments of the present disclosure may be provided as a method, system, or computer program product. Therefore, the embodiments of the present disclosure can take the form of an entirely hardware embodiment, an entirely software embodiment or an embodiment containing both hardware and software elements. Moreover, this disclosure can be in a form of one or more computer program products containing the computer-executable codes which can be implemented in the computer-executable non-transitory storage media (including but not limited to disk memory, CD-ROM, optical memory, etc.).

The present disclosure is described with reference to the flow charts and/or block diagrams of the method, device (system) and computer program product according to the embodiments of the present disclosure. It shall be understood that each flow and/or block in the flowcharts and/or block diagrams and a combination of the flows and/or blocks in the flowcharts and/or block diagrams can be implemented by computer program instructions. These computer program instructions can be provided to a general purpose computer, a special purpose computer, an embedded processor, or a processor of other programmable data processing devices so as to generate a machine for generating means for implementing the functions of one or more flows of a flowchart and/or one or more blocks of a block diagram by using the instructions executed by the computer or the processor of other programmable data processing devices.

These computer program instructions can also be stored in a computer readable memory guiding the computer or other programmable data processing devices to work in a particular way, such that the instructions stored in the computer readable memory generate an article of manufacture containing instruction means which implement the functions of one or more flows of a flowchart and/or one or more blocks in a block diagram.

These computer program instructions can also be loaded onto a computer or other programmable data processing devices such that a series of operational steps are performed on a computer or other programmable devices to produce computer-implemented processing, so that the instructions executed on a computer or other programmable devices provide steps for implementing the functions of one or more flows of a flowchart and/or one or more blocks of a block diagram.

The above content is only preferred embodiments of this present disclosure, but cannot be used for limiting this disclosure. Any modification, equivalent replacement and improvement, etc. within the spirit and principle of this disclosure shall be contained in the scope of protection of this disclosure.

1. A positioning method of an unmanned aerial vehicle, comprising:
receiving position information provided by a global positioning system (GPS) and position information provided by an auxiliary positioning system;
determining a positioning weight of the GPS and a positioning weight of the auxiliary positioning system; and
calculating a position of the unmanned aerial vehicle in a weighted manner according to the position information provided by the GPS, the position information provided by the auxiliary positioning system, the positioning weight of the GPS and the positioning weight of the auxiliary positioning system.

2. The positioning method of claim 1, wherein said determining a positioning weight of the GPS and a positioning weight of the auxiliary positioning system comprises:
calculating a GPS positioning error;
taking a physical quantity in negative correlation with the GPS positioning error as a GPS positioning accuracy coefficient and taking a physical quantity in positive correlation with signal quality information of the auxiliary positioning system as an auxiliary positioning accuracy coefficient; and
determining the positioning weight of the GPS and the positioning weight of the auxiliary positioning system according to the GPS positioning accuracy coefficient and the auxiliary positioning accuracy coefficient.

3. The positioning method of claim 2, wherein
a normalization operation is performed after taking reciprocal of the GPS positioning error to obtain the GPS positioning accuracy coefficient;
a normalization operation is performed on the signal quality information of the auxiliary positioning system to obtain the auxiliary positioning accuracy coefficient.

4. The positioning method of claim 2, wherein said calculating a GPS positioning error comprises:
receiving horizontal dilution of precision, vertical dilution of precision and time dilution of precision from a satellite; and
taking an arithmetic square root of a sum of squares of the horizontal dilution of precision, the vertical dilution of precision and the time dilution of precision as the GPS positioning error.

5. The positioning method of claim 1, wherein the auxiliary positioning system is a wireless positioning system, and the signal quality information of the auxiliary positioning system is wireless signal quality information.

6. The positioning method of claim 1, wherein the auxiliary positioning system is a vision auxiliary positioning system, and the signal quality information of the auxiliary positioning system is image quality information of an image obtained by the unmanned aerial vehicle taking pictures of a ground.

7. The positioning method of claim 5, wherein the wireless positioning system comprises: a Bluetooth positioning system, a wireless local area network positioning system, and a narrow bandwidth positioning system.

8-14. (canceled)

15. A positioning device of an unmanned aerial vehicle, comprising:
a processer; and
memory coupled to the processor and storing instructions that when executed by the processor, cause the processor to:
receive position information provided by a global positioning system (GPS) and position information provided by an auxiliary positioning system;
determine a positioning weight of the GPS and a positioning weight of the auxiliary positioning system; and
calculate a position of the unmanned aerial vehicle in a weighted manner according to the position information provided by the GPS, the position information provided by the auxiliary positioning system, the positioning weight of the GPS and the positioning weight of the auxiliary positioning system.

16. A non-transitory computer readable storage medium storing computer instructions which, when executed by a processor, cause the processor to:
receive position information provided by a global positioning system (GPS) and position information provided by an auxiliary positioning system;
determine a positioning weight of the GPS and a positioning weight of the auxiliary positioning system; and
calculate a position of the unmanned aerial vehicle in a weighted manner according to the position information provided by the GPS, the position information provided by the auxiliary positioning system, the positioning weight of the GPS and the positioning weight of the auxiliary positioning system.

17. The positioning device of claim 15, wherein determining a positioning weight of the GPS and a positioning weight of the auxiliary positioning system comprises:
calculating a GPS positioning error;
taking a physical quantity in negative correlation with the GPS positioning error as a GPS positioning accuracy coefficient and taking a physical quantity in positive correlation with signal quality information of the auxiliary positioning system as an auxiliary positioning accuracy coefficient; and
determining the positioning weight of the GPS and the positioning weight of the auxiliary positioning system according to the GPS positioning accuracy coefficient and the auxiliary positioning accuracy coefficient.

18. The positioning device of claim 17, wherein
a normalization operation is performed after taking reciprocal of the GPS positioning error to obtain the GPS positioning accuracy coefficient; and
a normalization operation is performed on the signal quality information of the auxiliary positioning system to obtain the auxiliary positioning accuracy coefficient.

19. The positioning device of claim 17, wherein calculating a GPS positioning error comprises:
receiving horizontal dilution of precision, vertical dilution of precision and time dilution of precision from a satellite; and
taking an arithmetic square root of a sum of squares of the horizontal dilution of precision, the vertical dilution of precision and the time dilution of precision as the GPS positioning error.

20. The positioning device of claim 15, wherein the auxiliary positioning system is a wireless positioning system, and the signal quality information of the auxiliary positioning system is wireless signal quality information.

21. The positioning device of claim 15, wherein the auxiliary positioning system is a vision auxiliary positioning system, and the signal quality information of the auxiliary positioning system is image quality information of an image obtained by the unmanned aerial vehicle taking pictures of a ground.

22. The positioning device of claim 20, wherein the wireless positioning system comprises:
a Bluetooth positioning system, a wireless local area network positioning system, and a narrow bandwidth positioning system.

23. The non-transitory computer readable storage medium of claim 16, wherein determining a positioning weight of the GPS and a positioning weight of the auxiliary positioning system comprises:
calculating a GPS positioning error;
taking a physical quantity in negative correlation with the GPS positioning error as a GPS positioning accuracy coefficient and taking a physical quantity in positive correlation with signal quality information of the auxiliary positioning system as an auxiliary positioning accuracy coefficient; and
determining the positioning weight of the GPS and the positioning weight of the auxiliary positioning system according to the GPS positioning accuracy coefficient and the auxiliary positioning accuracy coefficient.

24. The non-transitory computer readable storage medium of claim 23, wherein
a normalization operation is performed after taking reciprocal of the GPS positioning error to obtain the GPS positioning accuracy coefficient;
a normalization operation is performed on the signal quality information of the auxiliary positioning system to obtain the auxiliary positioning accuracy coefficient.

25. The non-transitory computer readable storage medium of claim 23, wherein calculating a GPS positioning error comprises:
receiving horizontal dilution of precision, vertical dilution of precision and time dilution of precision from a satellite; and
taking an arithmetic square root of a sum of squares of the horizontal dilution of precision, the vertical dilution of precision and the time dilution of precision as the GPS positioning error.

26. The non-transitory computer readable storage medium of claim 16, wherein the auxiliary positioning system is a wireless positioning system, and the signal quality information of the auxiliary positioning system is wireless signal quality information.

27. The non-transitory computer readable storage medium of claim 16, wherein the auxiliary positioning system is a vision auxiliary positioning system, and the signal quality information of the auxiliary positioning system is image quality information of an image obtained by the unmanned aerial vehicle taking pictures of a ground.
